(19) United States
(12) Patent Application Publication
(10) Pub. No.: US 2026/0361430 A1
(43) Pub. Date: Nov. 12, 2026

(54) SYSTEMS AND METHODS FOR A GENERALIZABLE ARTIFICAL INTELLIGENCE MODEL FOR MANAGEMENT

(71) Applicant: APPLE INC., Cupertino, CA (US)

(72) Inventors: Weidong Yang, San Diego, CA (US); Dawei Zhang, Saratoga, CA (US); Wei Zeng, San Diego, CA (US); Oghenekome Oteri, San Diego, CA (US); Hong He, San Jose, CA (US); Chunxuan Ye, San Diego, CA (US); Huaning Niu, San Jose, CA (US); Sigen Ye, San Diego, CA (US); Haitong Sun, Cupertino, CA (US); Ankit Bhamri, Bad Nauheim (DE)

(21) Appl. No.: 19/109,198

(22) PCT Filed: Aug. 10, 2023
(86) PCT No.: PCT/US2023/072050

§ 371 Date: Mar. 6, 2025

Related U.S. Application Data
(60) Provisional application No. 63/376,792, filed on Sep. 23, 2022.

(51) Int. Cl. H04B 17/318; H04B 7/06

(52) U.S. Cl. CPC H04B 17/328; H04B 7/0626

(57) ABSTRACT

Systems and methods for a generalizable artificial intelligence (AI) model for beam management in a wireless communication system are discussed herein. A user equipment (UE) generates reference signal measurements by measuring reference signals, wherein each reference signal corresponds to a transmission beam b of a set of transmission beams under an antenna polarization p of a set of antenna polarizations. The UE provides the reference signal measurements to an AI model that is configured to respond to this input with parameters for each transmission beam b under each polarization p. In some cases, the parameters are used by the UE to generate a channel matrix, which may be either fed back to the network or further analyzed by the UE to determine information corresponding to a dominant vector that is then fed back to the network. In other cases, the parameters themselves are fed back to the network for use.

### CROSS-REFERENCE TO RELATED APPLICATIONS

The present application claims the benefit of priority to the filing date of U.S. Provisional Patent Application No. 63/376,792 filed Sep. 23, 2022, entitled “GENERALIZABLE AI MODEL FOR BEAM MANAGEMENT,” the contents of which are incorporated herein by reference in their entirety.

### TECHNICAL FIELD

This application relates generally to wireless communication systems, including wireless communication systems implementing beam management mechanisms.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and Institute of Electrical and Electronics Engineers (IEEE) 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a method of a UE, according to embodiments discussed herein.

FIG. 2 illustrates a method of a RAN, according to embodiments discussed herein.

FIG. 3 illustrates a method of a UE, according to embodiments discussed herein.

FIG. 4 illustrates a method of a UE, according to embodiments discussed herein.

FIG. 5 illustrates an example architecture of a wireless communication system, according to embodiments disclosed herein.

FIG. 6 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

This disclosure establishes a connection between beam management and channel state information (CSI) feedback. From there, mechanisms for extracting key channel parameters for constructing a channel matrix are proposed. Feedback corresponding to this beam management process may leverage CSI feedback design, as will be described.

Further, with respect to model generalization aspects, it is proposed to use digital domain beam angles/phase ramps instead of actual beam angles in degrees as input to an artificial intelligence (AI) model.

### Discussion on Channel Models

Various multiple input multiple output (MIMO) channel models are now described.

Note in early studies on smart antennas, e.g. “Smart Antennas for Wireless Communications: Is-95 and Third Generation CDMA Applications” by Joseph C. Liberti and Theodore S. Rappaport, Prentice-Hall, 1999, various vector channels were proposed.

Further, for both beam management and CSI feedback, it may be that a MIMO channel as discussed in, for example, 3GPP Technical Report (TR) 38.901, “Study on Channel Model for Frequencies from 0.5 to 100 GHz,” version 17.0.0 (March 2023) (hereinafter “TR 38.901”) is particularly relevant.

In some embodiments, channel coefficients for each cluster n and each receiver and transmitter element pair u, s are generated.

In cases of non-line of sight (NLOS), channel coefficients of a ray m in cluster n for a link between a receive (Rx) antenna u and a transmit (Tx) antenna s at time t in a k-th frequency bin can be calculated as

$${H}_{u , s , n , m , k} ( t ) = {[ \begin{matrix}{F}_{rx , u , θ} ( {θ}_{n , m , ZOA} , {ϕ}_{n , m , ZOA} ) \\ {F}_{rx , u , ϕ} ( {θ}_{n , m , ZOA} , {ϕ}_{n , m , ZOA} )\end{matrix} ]}^{T} [ \begin{matrix}exp ( j {Φ}_{n , m}^{θθ} ) & \sqrt{{κ}_{n , m}^{- 1}} exp ( j {Φ}^{ϕϕ} ) \\ \sqrt{{κ}_{n , m}^{- 1}} exp ( j {Φ}^{ϕϕ} ) & exp ( j {Φ}_{n , m}^{ϕϕ} )\end{matrix} ] \cdot [ \begin{matrix}{F}_{tx , u , θ} ( {θ}_{n , m , ZOD} , {ϕ}_{n , m , ZOD} ) \\ {F}_{tx , u , ϕ} ( {θ}_{n , m , ZOD} , {ϕ}_{n , m , ZOD} )\end{matrix} ] \cdot exp ( j 2 π \frac{{f}_{k}}{c} ( {\hat{r}}_{rx , n , m}^{T} {\overline{d}}_{rx , u} + {\hat{r}}_{tx , n , m}^{T} {\overline{d}}_{tx , s} ) ) \cdot ( \sqrt{{P}_{n , m , k}} {10}^{( - {OL}_{n , m} ( {f}_{k} ) + {BL}_{n , m} ( {f}_{k} , t ) ) / 20} ) exp ( j 2 π \frac{{f}_{k}}{c} {\hat{r}}_{rx , n , m}^{T} \overline{v} t )$$

(see TR 38.901 Section 8.4 formula 27) where F_{rx,u,θ} and F_{rx,u,φ} are the receive antenna element u field patterns in the direction of the spherical basis vectors, \hat{θ} and \hat{φ} respectively, F_{tx,s,θ} and F_{tx,s,φ} are the transmit antenna element s field patterns in the direction of the spherical basis vectors, \hat{θ} and \hat{φ} respectively. The delay (time of arrival (TOA)) for ray m in cluster n for a link between Rx antenna u and Tx antenna s may be given by:

$${τ}_{u , s , n , m} = {τ}_{n} + {τ}_{n , m}^{′} - \frac{1}{c} {\hat{r}}_{rx , n , m}^{T} \cdot {\overline{d}}_{rx , u} - \frac{1}{c} {\hat{r}}_{tx , n , m}^{T} \cdot {\overline{d}}_{tx , s}$$

(see TR 38.901 Section 8.4 formula 28).

For the m-th ray within n-th cluster, \hat{r}_{rx,n,m} is the spherical unit vector with azimuth arrival angle φ_{n,m,AOA} and elevation arrival angle θ_{n,m,ZOA}, given by

$${\hat{r}}_{rx , n , m} = [ \begin{matrix}sin {θ}_{n , m , ZOA} cos {φ}_{n , m , AOA} \\ sin {θ}_{n , m , ZOA} sin {φ}_{n , m , AOA} \\ cos {θ}_{n , m , ZOA}\end{matrix} ]$$

(see TR 38.901 Section 8.4 formula 28), and \hat{r}_{tx,n,m} is the spherical unit vector with azimuth departure angle φ_{n,m,AOD} and elevation departure angle θ_{n,m,ZOA}, given by

$${\hat{r}}_{tx , n , m} = [ \begin{matrix}sin {θ}_{n , m , ZOD} cos {φ}_{n , m , AOD} \\ sin {θ}_{n , m , ZOD} sin {φ}_{n , m , AOD} \\ cos {θ}_{n , m , ZOD}\end{matrix} ]$$

(see TR 38.901 Section 8.4 formula 30).

Further, d̅_{rx,u} is the location vector of receive antenna element u and d̅_{tx,s} is the location vector of transmit antenna element s, κ_{n,m} is the cross polarisation power ratio in linear scale. If polarisation is not considered, the 2×2 polarisation matrix can be replaced by the scalar exp(jΦ_{n,m}) and only vertically polarised field patterns are applied.

The Doppler frequency component is calculated from the arrival angles (angle of arrival (AOA), zenith angle of arrival (ZOA)), and the user terminal (UT) velocity vector v̅ with speed ν, travel azimuth angle φᵥ, elevation angle θᵥ and is given by

v̅=v·[sin θᵥ cos φv sin θv sin φv cos θᵥ]_{T}

(see TR 38.901 Section 8.4 formula 31).

In cases of line of sight (LOS), the channel coefficient is calculated in the same way as in TR 38.901 Section 8.4 formula 27 (as provided above), except for n=1:

$${H}_{u , s , n = 1 , k} ( t ) = {[ \begin{matrix}{F}_{rx , u , θ} ( {θ}_{LOS , ZOA} , {ϕ}_{LOS , AOA} ) \\ {F}_{rx , u , ϕ} ( {θ}_{LOS , ZOA} , {ϕ}_{LOS , AOA} )\end{matrix} ]}^{T} [ \begin{matrix}exp ( j {Φ}_{LOS}^{θθ} ) & 0 \\ 0 & exp ( j {Φ}_{LOS}^{ϕϕ} )\end{matrix} ] \cdot [ \begin{matrix}{F}_{tx , u , θ} ( {θ}_{LOS , ZOD} , {ϕ}_{LOS , AOD} ) \\ {F}_{tx , u , ϕ} ( {θ}_{LOS , ZOD} , {ϕ}_{LOS , AOD} )\end{matrix} ] \cdot exp ( j 2 π \frac{{f}_{k}}{c} ( {\hat{r}}_{rx , LOS}^{T} {\overline{d}}_{rx , u} + {\hat{r}}_{tx , LOS}^{T} {\overline{d}}_{tx , s} ) ) \cdot ( \sqrt{{P}_{1 , k}} {10}^{( - {OL}_{n , m = 1} + {BL}_{n , m = 1} ( {f}_{k} , t ) ) / 20} ) exp ( j 2 π \frac{{f}_{k}}{c} {\hat{r}}_{rx , LOS}^{T} \overline{v} t )$$

(see TR 38.901 Section 8.4 formula 32) where the corresponding delay (TOA) for cluster n=1 for a link between Rx antenna u and Tx antenna s may be given by

$${τ}_{u , s , n = 1} = {τ}_{n} - \frac{1}{c} {\hat{r}}_{rx , LOS}^{T} \cdot {\overline{d}}_{rx , u} - \frac{1}{c} {\hat{r}}_{tx , LOS}^{T} \cdot {\overline{d}}_{tx , s}$$

With respect to cases using formulas described above (e.g., TR 38.901 Section 8.4 formula 27 and TR 38.901 Section 8.4 formula 32), it may be that the oxygen absorption loss, OL_{n,m}(f), for each ray m in cluster n at carrier frequency f may be modelled as

$${OL}_{n , m} ( f ) = α ( f ) / 1000 c \cdot [ {τ}_{n} + {τ}_{n , m}^{′} + {min}_{{l}_{RT}} ( {τ}_{{l}_{RT}}^{′} ) ] [ dB ]$$

where:
α(f) is the frequency dependent oxygen loss per distance (dB/km) characterized in Clause 7.6.1;
c is speed of light (m/s); and
τₙ is the delay(s) obtained from a Step 3 for deterministic clusters and from a

Step 5 for random clusters. Note also that min(τₙ′) is from the output of Step 3. See TR 38.901 Section 8.4 formula 33.

In some situations (for example, in the contexts of TR 38.901 Section 8.4 formula 27 and Section 8.4 formula 32), blockage modeling is an add-on feature. If the blockage model is applied, the blockage loss, BL_{n,m}(f,t) in unit of dB, for each ray m in cluster n at carrier frequency f and time t is modeled, for example, in a same way as given in TR 38.901 Clause 7.6.4; otherwise BL_{n,m}(f,t)=0 dB for all f and t.

With reference to the term

$$exp ( j 2 π \frac{{f}_{k}}{c} {\hat{r}}_{rx , n , m}^{T} \overline{v} t )$$

(e.g., as found in TR 38.901 Section 8.4 formula 27 as described above), it can be seen the Doppler shift can be different among rays (note that n is the ray index for cluster m). Note that with respect to considerations of spatial consistency of the generated MIMO channel, there may be modifications/additions to the channel generation steps, which can be found in TR 38.901. Such modifications/additions do not change the validity of embodiments discussed herein.

In 3GPP NR Release 16 (Rel-16) Type II CSI feedback design, the precoder for spatial layer n may be given by

$$[ \begin{matrix}{\sum }_{p = 0 , b = 1}^{{B}_{0}} A ( {θ}_{b , p} , {ϕ}_{b , p} ) {C}_{b , p} δ ( t - {τ}_{b , p} ) \\ {\sum }_{p = 1 , b = 1}^{{B}_{1}} A ( {θ}_{b , p} , {ϕ}_{b , p} ) {C}_{b , p} δ ( t - {τ}_{b , p} )\end{matrix} ]$$

where p is the polarization index (e.g., p=0 for polarization at +45° and p=1 for polarization at −45°), there are B₀ significant beams for Tx antennas at polarization index 0, and B₁ significant beam for Tx antennas at polarization index 1. For polarization index p, b is the ray index for a ray with departure angles (θ_{b,p}, φ_{b,p}), A(θ_{b,p}, φ_{b,p}) is the array response for (θ, φ), τ_{b,p} is the relative delay, and a_{b} is the path gain including amplitude and phase for ray b. Assume regular antenna element arrangement, then (θ_{b,p}, φ_{b,p}) can be mapped to (i₁, i₂, p₁, p₂), where p₁, 0≤p₁≤O₁−1 and p₂, 0≤p₂≤O₂−1 are oversampling factors for the vertical domain and the horizontal domain respectively, and (i₁, i₂) are the spatial beam indices.

It can be observed that there can be multiple rays with the same departure angles but different relative delays, and, when considering from the perspective of relative delay, that there can be rays with different departure angles but the same relative delay

A discussion of 3GPP NR Release 18 (Rel-18) precoding matrix indicator (PMI) design now follows. Let C_{b,p} be the complex coefficient connecting a spatial beam, a delay and a Doppler shift, and b be a beam index which roughly corresponds to a ray in a cluster as the TR 38.901 MIMO model. In some cases, it may be proposed that In Rel-18, a precoder can be represented by

$$[ \begin{matrix}{\sum }_{p = 0 , b = 1}^{{B}_{0}} A ( {θ}_{b , p} , {ϕ}_{b , p} ) {C}_{b , p} {e}^{2 π {f}_{b , p} t} δ ( t - {τ}_{b , p} ) \\ {\sum }_{p = 1 , b = 1}^{{B}_{1}} A ( {θ}_{b , p} , {ϕ}_{b , p} ) {C}_{b , p} {e}^{2 π {f}_{b , p} t} δ ( t - {τ}_{b , p} )\end{matrix} ]$$

(note that with respect to the Rel-16 precoder design discussed above, there is now an additional term f_{b,p} for Doppler shift).

Similar to the design in Rel-16, the linear combination (LC) coefficient with the largest amplitude (the strongest LC coefficient) can be found (from LC coefficients at both polarizations from all sheets). With respect to such cases, it may be that the strongest LC coefficient C_{\hat{b},p̅}, is associated with polarization index p̅, and the corresponding beam index is \hat{b} (or understood in the digital domain by (î₁, î₂)). Then, C_{\hat{b},p̅} may be used to normalize other coefficients, and a constant frequency offset can be added to all beams, such that f_{\hat{b},p̅} can be used to shift the frequency offset at other LC coefficients:

$$[ \begin{matrix}{\sum }_{p = 0 , b = 1}^{{B}_{0}} A ( {θ}_{b , p} , {ϕ}_{b , p} ) {C}_{b , p} {e}^{2 π {f}_{b , p} t} δ ( t - {τ}_{b , p} ) \\ {\sum }_{p = 1 , b = 1}^{{B}_{1}} A ( {θ}_{b , p} , {ϕ}_{b , p} ) {C}_{b , p} {e}^{2 π {f}_{b , p} t} δ ( t - {τ}_{b , p} )\end{matrix} ]$$

$$⇓$$

$$[ \begin{matrix}{\sum }_{p = 0 , b = 1}^{{B}_{0}} A ( {θ}_{b , p} , {ϕ}_{b , p} ) \frac{{C}_{b , p}}{{C}_{\hat{b} , \tilde{p}}} {e}^{2 π {f}_{b , p} t} δ ( t - {τ}_{b , p} ) \\ {\sum }_{p = 1 , b = 1}^{{B}_{1}} A ( {θ}_{b , p} , {ϕ}_{b , p} ) \frac{{C}_{b , p}}{{C}_{\hat{b} , \tilde{p}}} {e}^{2 π {f}_{b , p} t} δ ( t - {τ}_{b , p} )\end{matrix} ]$$

$$⇓$$

$$[ \begin{matrix}{\sum }_{p = 0 , b = 1}^{{B}_{0}} A ( {Q}_{1 , 1} ( {θ}_{b , p} ) , {Q}_{1 , 2} ( {ϕ}_{b , p} ) ) {Q}_{3} ( \frac{{C}_{b , p}}{{C}_{\hat{b} , \tilde{p}}} ) {e}^{2 π {Q}_{4} ( {f}_{b , p} - {f}_{\hat{b} , \overline{p}} ) t} δ ( t - {Q}_{2} ( {τ}_{b , p} ) ) \\ {\sum }_{p = 1 , b = 1}^{{B}_{1}} A ( {Q}_{1 , 1} ( {θ}_{b , p} ) , {Q}_{1 , 2} ( {ϕ}_{b , p} ) ) {Q}_{3} ( \frac{{C}_{b , p}}{{C}_{\hat{b} , \overline{p}}} ) {e}^{2 π {Q}_{4} ( {f}_{b , p} - {f}_{\hat{b} , \overline{p}} ) t} δ ( t - {Q}_{2} ( {τ}_{b , p} ) )\end{matrix} ]$$

Further, τ_{\hat{b},p̅} can be used to further shift the strongest complex coefficient to the first FD component (or the first tap):

$${\sum }_{b} A ( {θ}_{b , p} , {ϕ}_{b , p} ) {C}_{b , p} {e}^{2 π {f}_{b , p} t} δ ( t - {τ}_{b , p} )$$

$$⇓$$

$${\sum }_{b} A ( {θ}_{b , p} , {ϕ}_{b , p} ) \frac{{C}_{b , p}}{{C}_{\hat{b} , \overline{p}}} {e}^{2 {π ( {f}_{b , p} - {f}_{\hat{b} , \overline{p}} )}^{t}} δ ( t - ( {τ}_{b , p} - {τ}_{\hat{b} , \overline{p}} ) )$$

$$⇓$$

$$\begin{matrix}{\sum }_{b} A ( {Q}_{1 , 1} ( {θ}_{b , p} ) , {Q}_{1 , 2} ( {ϕ}_{b , p} ) ) {Q}_{3} ( \frac{{C}_{b , p}}{{C}_{\hat{b} , \overline{p}}} ) {e}^{2 π {{Q}_{4} ( {f}_{b , p} - {f}_{\hat{b} , \overline{p}} )}^{t}} \\ δ ( t - {Q}_{2} ( {τ}_{b , p} - {τ}_{\hat{b} , \overline{p}} ) )\end{matrix}$$

$$[ \begin{matrix}{\sum }_{p = 0 , b = 1}^{{B}_{0}} A ( {θ}_{b , p} , {ϕ}_{b , p} ) {C}_{b , p} {e}^{2 π {f}_{b , p} t} δ ( t - {τ}_{b , p} ) \\ {\sum }_{p = 1 , b = 1}^{{B}_{1}} A ( {θ}_{b , p} , {ϕ}_{b , p} ) {C}_{b , p} {e}^{2 π {f}_{b , p} t} δ ( t - {τ}_{b , p} )\end{matrix} ]$$

$$⇓$$

$$[ \begin{matrix}{\sum }_{p = 0 , b = 1}^{{B}_{0}} A ( {θ}_{b , p} , {ϕ}_{b , p} ) \frac{{C}_{b , p}}{{C}_{\hat{b} , \overline{p}}} {e}^{2 {π ( {f}_{b , p} - {f}_{\hat{b} , \overline{p}} )}^{T}} δ ( t - {Q}_{2} ( {τ}_{b , p} - {τ}_{\hat{b} , \overline{p}} ) ) \\ {\sum }_{p = 1 , b = 1}^{{B}_{1}} A ( {θ}_{b , p} , {ϕ}_{b , p} ) \frac{{C}_{b , p}}{{C}_{\hat{b} , \overline{p}}} {e}^{2 {π ( {f}_{b , p} - {f}_{\hat{b} , \overline{p}} )}^{T}} δ ( t - {Q}_{2} ( {τ}_{b , p} - {τ}_{\hat{b} , \overline{p}} ) )\end{matrix} ]$$

$$⇓$$

$$[ \begin{matrix}{\sum }_{p = 0 , b = 1}^{{B}_{0}} A ( {Q}_{1 , 1} ( {θ}_{b , p} ) , {Q}_{1 , 2} ( {ϕ}_{b , p} ) ) {Q}_{3} ( \frac{{C}_{b , p}}{{C}_{\hat{b} , \overline{p}}} ) {e}^{2 π {{Q}_{4} ( {f}_{b , p} - {f}_{\hat{b} , \overline{p}} )}^{t}} \\ δ ( t - {Q}_{2} ( {τ}_{b , p} - {τ}_{\hat{b} , \overline{p}} ) ) \\ {\sum }_{p = 1 , b = 1}^{{B}_{0}} A ( {Q}_{1 , 1} ( {θ}_{b , p} ) , {Q}_{1 , 2} ( {ϕ}_{b , p} ) ) {Q}_{3} ( \frac{{C}_{b , p}}{{C}_{\hat{b} , \overline{p}}} ) {e}^{2 π {{Q}_{4} ( {f}_{b , p} - {f}_{\hat{b} , \overline{p}} )}^{t}} \\ δ ( t - {Q}_{2} ( {τ}_{b , p} - {τ}_{\hat{b} , \overline{p}} ) )\end{matrix} ]$$

Note however, it is also possible not to shift the strongest coefficient to the DC tone, i.e. effectively the following high level processing flow is used:

$$[ \begin{matrix}{\sum }_{p = 0 , b = 1}^{{B}_{0}} A ( {θ}_{b , p} , {ϕ}_{b , p} ) {C}_{b , p} {e}^{2 π {f}_{b , p} t} δ ( t - {τ}_{b , p} ) \\ {\sum }_{p = 1 , b = 1}^{{B}_{1}} A ( {θ}_{b , p} , {ϕ}_{b , p} ) {C}_{b , p} {e}^{2 π {f}_{b , p} t} δ ( t - {τ}_{b , p} )\end{matrix} ]$$

$$⇓$$

$$[ \begin{matrix}{\sum }_{p = 0 , b = 1}^{{B}_{0}} A ( {θ}_{b , p} , {ϕ}_{b , p} ) \frac{{C}_{b , p}}{{C}_{\hat{b} , \overline{p}}} {e}^{2 π {f}_{b , p} t} δ ( t - ( {τ}_{b , p} - {τ}_{\hat{b} , \overline{p}} ) ) \\ {\sum }_{p = 1 , b = 1}^{{B}_{1}} A ( {θ}_{b , p} , {ϕ}_{b , p} ) \frac{{C}_{b , p}}{{C}_{\hat{b} , \overline{p}}} {e}^{2 π {f}_{b , p} t} δ ( t - ( {τ}_{b , p} - {τ}_{\hat{b} , \overline{p}} ) )\end{matrix} ]$$

$$⇓$$

$$[ \begin{matrix}{\sum }_{p = 0 , b = 1}^{{B}_{0}} A ( {Q}_{1 , 1} ( {θ}_{b , p} ) , {Q}_{1 , 2} ( {ϕ}_{b , p} ) ) {Q}_{3} ( \frac{{C}_{b , p}}{{C}_{\hat{b} , \overline{p}}} ) {e}^{2 π {{Q}_{4} ( {f}_{b , p} - {f}_{\hat{b} , \overline{p}} )}^{t}} \\ δ ( t - {Q}_{2} ( {τ}_{b , p} - {τ}_{\hat{b} , \overline{p}} ) ) \\ {\sum }_{p = 1 , b = 1}^{{B}_{0}} A ( {Q}_{1 , 1} ( {θ}_{b , p} ) , {Q}_{1 , 2} ( {ϕ}_{b , p} ) ) {Q}_{3} ( \frac{{C}_{b , p}}{{C}_{\hat{b} , \overline{p}}} ) {e}^{2 π {{Q}_{4} ( {f}_{b , p} - {f}_{\hat{b} , \overline{p}} )}^{t}} \\ δ ( t - {Q}_{2} ( {τ}_{b , p} - {τ}_{\hat{b} , \overline{p}} ) )\end{matrix} ]$$

Accordingly, in discussion herein, the act of shifting to DC tone may be considered an optional step.

To control the feedback overhead, it may be that only larger

$$\frac{{C}_{b , p}}{{C}_{\hat{b} , \hat{p}}}$$

and the corresponding (θ_{b,p}, φ_{b,p}), Δf_{b,p}=f_{b,p}−f_{\hat{b},p̅} and Δθ_{b,p}=τ_{b,p}−τ_{\hat{b},p̅} need to be feed back.

In other cases where feedback overhead is not an issue, then feeding back

$${θ}_{b , p} , {ϕ}_{b , p} , \frac{{C}_{b , p}}{{C}_{\hat{b} , \hat{p}}} , ( {f}_{b , p} - {f}_{\hat{b} , \hat{p}} ) , {τ}_{b , p} - {τ}_{\hat{b} , \hat{p}} )$$

is possible. Since feedback overhead in many cases is indeed a concern, then quantizations applied to these quantities may be used.

The quantizers may be denoted as
spatial beam selection and quantization Q_{1,1} and Q_{1,2},
delay tap (also called FD component in RAN1) quantization Q₂,
LC coefficient quantization Q₃, and
Doppler component (or time domain (TD) component) selection/quantization Q₄.

Conceptually, it will be understood that if

$$\frac{{C}_{b , p}}{{C}_{\hat{b} , \overline{p}}}$$

is small, omitting it (and corresponding quantities) will not ultimately amount to too much difference/change in the precoder. In such cases, the manner of indicating the omission of small

$$\frac{{C}_{b , p}}{{C}_{\hat{b} , \overline{p}}}$$

may also be considered.

It has been recognized that the formulation for precoders as discussed above can also be used for channel response between network and a single receive antenna at UE side. As compared with a MIMO channel model (for example, as captured in TR 38.901), the formulation can help build an intuitive understanding of channel propagation.

Discussion on Beam Management: Connection with CSI feedback

There may be two approaches in constructing an AI model for beam management. Under a first approach, as each cell is different, the cell terrain information may be built in the AI model itself. In such cases, it may be expected the model performs well for the cell the AI cell is trained with, but that it does not necessarily generalize well at other cells.

Under a second approach, by the universal approximation theorem of neural networks (see, e.g., https://en.wikipedia.org/wiki/Universal_approximation_theorem), the AI model may be treated as a generic estimator from interpolation. While such an AI model may not perform as well as a cell-specific AI model that is for a particular cell, as only non-cell specific interpolation/estimation is performed by the model, it is expected that the model should generalize more readily than in the cell-specific model case.

Conceptually, through the use of multiple analog beams (analog beamforming weight vectors), the channel response matrix can be constructed from various observations. In one method, the maximum likelihood fitting of a single θ can be conducted by fitting |A(θ)^{T}W(m)| at a number of m's with the observed reference signal received powers (RSRPs) at the beams m. In one example, m=1, 3, 7, 8, 9, 10, and we have the RSRP values formed into a vector:

$$r = [ \begin{matrix}{r}_{1} \\ {r}_{3} \\ {r}_{7} \\ {r}_{8} \\ {r}_{9} \\ {r}_{10}\end{matrix} ]$$

with the test vector is given by

$$[ \begin{matrix}{t}_{1} \\ {t}_{3} \\ {t}_{7} \\ {t}_{8} \\ {t}_{9} \\ {t}_{10}\end{matrix} ]$$

where tₖ=|A(θ)^{T}W(k)|. To match the profile, the normalized inner product of two vectors, remniscient of cosine similarity, may be used. It can be seen as long as the number of measurements is larger than the number of unknown parameters in the channel model, the channel can be estimated up to a scaling factor (note that g is hard to estimate).

In realistic channel propagation conditions the number of AoDs/ZoDs may be more than 1, which may motivate the use of additional beam measurements to reconstruct the channel. It can be seen that the channel matrix is parameterized as follows:

$$H ( t ) = [ \begin{matrix}{\sum }_{p = 0 , b = 1}^{{B}_{0}} A ( {θ}_{b , p} , {ϕ}_{b , p} ) \frac{{C}_{b , p}}{{C}_{\hat{b} , \overline{p}}} {e}^{2 π {f}_{b , p} t} δ ( t - {τ}_{b , p} ) \\ {\sum }_{p = 1 , b = 1}^{{B}_{1}} A ( {θ}_{b , p} , {ϕ}_{b , p} ) \frac{{C}_{b , p}}{{C}_{\hat{b} , \overline{p}}} {e}^{2 π {f}_{b , p} t} δ ( t - {τ}_{b , p} )\end{matrix} ]$$

Key parameters from this channel matrix may be extracted.

Focusing on beam management case 1 (the case of spatial domain prediction), it may be assumed that f_{b,p}=0. Then, to construct the channel, the parameters of interest may be θ_{b,p}, φ_{b,p},

$$\frac{{C}_{b , p}}{{C}_{\hat{b} , \overline{p}}} ,$$

and τ_{b,p}.

It is understood that estimates of these parameters can be produced by an AI model. With respect to each ray, four parameters are needed in its representation, and the number of rays/clusters may be limited to a relatively small number to avoid posing an unsolvable/overly complex problem to the AI model. Once the parameters for the dominant rays are known, then singular value decomposition (SVD) can be applied to the channel matrix in subbands or to a wideband covariance matrix built from the channel matrix. The resulting dominant singular vector then is the best precoder for analog beamforming.

In some implementations, gain control in analog beamforming may be challenging, so limiting the result to a phase adjustment component has attendant benefits. Accordingly, in some cases, only the phase part of the dominant singular vector may be used.

Accordingly, for beam management case 1, it is proposed to train an AI model with θ_{b,p}, φ_{b,p},

$$\frac{{C}_{b , p}}{{C}_{\hat{b} , \overline{p}}} ,$$

and τ_{b,p} as output. The number of rays/clusters (i.e. the range of p) is a hyperparameter. The UE may then reconstruct the channel matrix using these parameters. The channel matrix may be reconstructed in some such cases using the formula

$$H ( t ) = [ \begin{matrix}{\sum }_{p = 0 , b = 1}^{{B}_{0}} A ( {θ}_{b , p} , {ϕ}_{b , p} ) \frac{{C}_{b , p}}{{C}_{\hat{b} , \overline{p}}} δ ( t - {τ}_{b , p} ) \\ {\sum }_{p = 1 , b = 1}^{{B}_{1}} A ( {θ}_{b , p} , {ϕ}_{b , p} ) \frac{{C}_{b , p}}{{C}_{\hat{b} , \overline{p}}} δ ( t - {τ}_{b , p} )\end{matrix} ]$$

In some cases, the UE may feed back the channel matrix to the network.

In some cases the UE may instead use the channel matrix to determine the dominant singular vector for the wideband covariance matrix from the inference from the AI model. This dominant single vector may be fed back to the network. Alternatively the phase part of the dominant singular vector is fed back to the network.

It is further contemplated that in other alternative cases, instead of reconstructing the channel matrix at UE side, the UE feeds back the parameters themselves to the network (e.g., feeds back the values of θ_{b,p}, φ_{b,p},

$$\frac{{C}_{b , p}}{{C}_{\hat{b} , \overline{p}}} ,$$

and τ_{b,p} to the network) for channel construction at the network. The network can then use these parameters to deduce the best beam for itself (e.g., using an AI model and channel reconstruction as described). The network may determine the best beam with respect to a period (e.g., 5 ms) following the receipt of the feedback.

In further alternative cases, instead of feeding back θ_{b,p}, φ_{b,p},

$$\frac{{C}_{b , p}}{{C}_{\hat{b} , \overline{p}}} ,$$

and τ_{b,p} for a number of rays, a Type II CSI feedback design may instead be reused (e.g., Rel-16 Type II CSI feedback may be reused). Note however, that in this case, a measurement resources configuration may be according to a beam management mechanism rather than a mechanism for CSI feedback. For beam management, multiple measurement resources (channel state information reference signal (CSI-RS) resources and/or synchronization signal blocks (SSBs)) with a single port or two ports may be configured for beam management. However, for CSI feedback, a single CSI-RS resource with multiple ports may configured. To inform the UE of the antenna port configuration, parameters like N1/N2, which specify the number of antenna ports in the vertical domain and horizontal domain at a given polarization, are used to characterize the antenna array and signaled as part of an RRC configuration from network. To facilitate the parameter estimation of back θ_{b,p}, φ_{b,p},

$$\frac{{C}_{b , p}}{{C}_{\hat{b} , \overline{p}}} ,$$

and τ_{b,p} and (re)-construction of the channel matrix, etc., it is contemplated that N1 and N2 can be signaled to the UE in the case of AI beam management also.

For beam management case 2, Doppler shift may be considered as well. Accordingly, to construct the channel, the parameters of interest may be θ_{b,p}, φ_{b,p},

$$\frac{{C}_{b , p}}{{C}_{\hat{b} , \overline{p}}} ,$$

τ_{b,p}, and f_{b,p}−f_{\hat{b},p̅}.

$$( or {θ}_{b , p} , {ϕ}_{b , p} , \frac{{C}_{b , p}}{{C}_{\hat{b} , \overline{p}}} , {τ}_{b , p} , and {f}_{b , p} ) .$$

Accordingly, for beam management case 2, it is proposed to train an AI model with θ_{b,p}, φ_{b,p},

$$\frac{{C}_{b , p}}{{C}_{\hat{b} , \overline{p}}} ,$$

τ_{b,p}, and f_{b,p}−f_{\hat{b},p̅} as output. The number of rays/clusters (i.e. the range of p) is a hyperparameter. The UE may then reconstruct the channel matrix using these parameters. The channel matrix may be reconstructed in some such cases using the formula

$$H ( t ) = [ \begin{matrix}{\sum }_{p = 0 , b = 1}^{{B}_{0}} A ( {θ}_{b , p} , {ϕ}_{b , p} ) \frac{{C}_{b , p}}{{C}_{\hat{b} , \overline{p}}} {e}^{2 π ( {f}_{b , p} - {f}_{\hat{b} , \overline{p}} ) t} δ ( t - {τ}_{b , p} ) \\ {\sum }_{p = 1 , b = 1}^{{B}_{1}} A ( {θ}_{b , p} , {ϕ}_{b , p} ) \frac{{C}_{b , p}}{{C}_{\hat{b} , \overline{p}}} {e}^{2 π ( {f}_{b , p} - {f}_{\hat{b} , \overline{p}} ) t} δ ( t - {τ}_{b , p} )\end{matrix} ]$$

Alternatively, again for beam management case 2, it is proposed to train an AI model with θ_{b,p}, φ_{b,p}

$$\frac{{C}_{b , p}}{{C}_{\hat{b} , \overline{p}}} ,$$

τ_{b,p}, and f_{b,p} as output. The number of rays/clusters (i.e. the range of p) is a hyperparameter. The UE may then reconstruct the channel matrix using these parameters. The channel matrix may be reconstructed in some such cases using the formula

$$H ( t ) = [ \begin{matrix}{\sum }_{p = 0 , b = 1}^{{B}_{0}} A ( {θ}_{b , p} , {ϕ}_{b , p} ) \frac{{C}_{b , p}}{{C}_{\hat{b} , \overline{p}}} {e}^{2 π {f}_{b , p} t} δ ( t - {τ}_{b , p} ) \\ {\sum }_{p = 1 , b = 1}^{{B}_{1}} A ( {θ}_{b , p} , {ϕ}_{b , p} ) \frac{{C}_{b , p}}{{C}_{\hat{b} , \overline{p}}} {e}^{2 π {f}_{b , p} t} δ ( t - {τ}_{b , p} )\end{matrix} ]$$

In some cases, the UE may feed back the channel matrix to the network at one or more time instances.

In some cases, at one or more time instances, the UE may instead use the channel matrix to determine the dominant singular vector for the wideband covariance matrix from the inference from the AI model. This dominant single vector at one or more time instances may be fed back to the network. Alternatively the phase part of the dominant singular vector is fed back to the network.

It is further contemplated that in other alternative cases, instead of reconstructing the channel matrix at UE side, the UE feeds back the parameters themselves to the network (e.g., feeds back the values of θ_{b,p}, φ_{b,p},

$$\frac{{C}_{b , p}}{{C}_{\hat{b} , \overline{p}}} ,$$

τ_{b,p}, and f_{b,p}−f_{\hat{b},p̅}

$$( or {θ}_{b , p} , {ϕ}_{b , p} , \frac{{C}_{b , p}}{{C}_{\hat{b} , \overline{p}}} , {τ}_{b , p} , and {f}_{b , p} )$$

to the network) for channel construction at the network. The network can then use these parameters to deduce the best beam for itself (e.g., using an AI model and channel matrix reconstruction as described). The network may determine the best beam with respect to a period (e.g., 5 ms) following the receipt of the feedback.

In further alternative cases, instead of feeding back θ_{b,p}, φ_{b,p},

$$\frac{{C}_{b , p}}{{C}_{\hat{b} , \overline{p}}} ,$$

τ_{b,p}, and f_{b,p}−f_{\hat{b},p̅} for a number of rays, a Type II CSI feedback design may instead be reused (e.g., Rel-18 Type II CSI feedback may be reused, where the UE feeds back channel parameters according to the Rel-18 design). Note however, that in this case, a measurement resources configuration may be according to a beam management mechanisim rather than a mechanism for CSI feedback. For beam management, multiple measurement resources (CSI-RS resources and/or SSBs) with a single port or two ports may be configured for beam management. However, for CSI feedback, a single CSI-RS resource with multiple ports may be configured. To inform the UE of the antenna port configuration, parameters like N1/N2, which specify the number of antenna ports in the vertical domain and horizontal domain at a given polarization, are used to characterize the antenna array and signaled as part of RRC configuration from network. To facilitate the parameter estimation of back θ_{b,p}, φ_{b,p},

$$\frac{{C}_{b , p}}{{C}_{\hat{b} , \overline{p}}} ,$$

and τ_{b,p} and (re)-construction of the channel matrix, etc., it is contemplated that N1 and N2 can be signaled to the UE for AI beam management also.

### Considerations with Respect to Generalization

With respect to the generalization of methods discussed herein, antenna element spacing aspects are now discussed. A vertical spacing between antenna elements may be denoted as d_{V} and a horizontal antenna spacing between antenna elements may be denoted as d_{H}.

Note that in practical antenna module design, d_{V} and d_{H} are not necesarily at half wavelength (as often assumed in array signal processing). To illustrate this point, we assume the antenna array is a 1D array instead of 2D array (as often assumed for NR). Then, the array response is given by

$$A ( θ ) = [ \begin{matrix}1 \\ {e}^{- j 2 π {f}_{c} τ} \\ . \\ . \\ . \\ {e}^{- j ( {N}_{1} - 1 ) π {f}_{c} τ}\end{matrix} ]$$

where τₖ=d_{H} sin θ/c, f_{c} is the carrier frequency in Hertz (Hz), and c is the speed of light in meters per second (m/s).

As the UE is not aware of the antenna spacings d_{H} and d_{V} (in this particular case only d_{H} is relevant), the UE is actually using DFT vectors to match the array response. In a simplistic setup with a single path from network to the UE and perfect time synchronization, the channel response matrix from the network to a single UE antenna can be written as

gA(θ)

where g is the complex gain factor.

For Type II CSI feedback, the precoders tested by the UE can be written as

$$W ( m ) = [ \begin{matrix}1 \\ {e}^{- j 2 π m / ( {N}_{1} {O}_{1} )} \\ . \\ . \\ . \\ {e}^{- j 2 π ( {N}_{1} - 1 ) m / ( {N}_{1} {O}_{1} )}\end{matrix} ]$$

Then the beamformed channel is given by

$${A ( θ )}^{T} W ( m ) = {\sum }_{n = 0}^{{N}_{1} - 1} {e}^{- jn 2 π {d}_{H} / λ sin ( θ )} {e}^{- j 2 π nm / ( {N}_{1} {O}_{1} )} = \frac{{e}^{- j 2 π N ( {d}_{H} / λ sin ( θ ) + m / ( {N}_{1} {O}_{1} ) )} - 1}{{e}^{- j 2 π ( {d}_{H} / λ sin ( θ ) + m / ( {N}_{1} {O}_{1} ) )} - 1}$$

The amplitude of the composite channel A(θ)^{T}W(m) is maximized at an m so

mod(d_{H}/λ sin(θ)+m/(N₁O₁),1)≈0 or mod(d_{H}/λ sin(θ)+m/(N₁O₁),1)≈1.

Consider a case where propagation conditions between the network and the UE are not modified by the use of different antenna modules at the network. Then, the best beam forming weight vector may be given by

mₒₚₜ=mod(−(N₁O₁)d_{H}/λ sin(θ),N₁O₁).

In one implementation, d_{H}=½λ. Then:

mₒₚₜ=mod(−(N₁O₁)d_{H}/λ sin(θ),N₁O₁)=mod(−(N₁O₁)½ sin(θ),N₁O₁).

In another implementation, d_{H}=⅖λ. Then:

mₒₚₜ=mod(−(N₁O₁)d_{H}/λ sin(θ),N₁O₁)=mod(−(N₁O₁)⅖ sin(θ),N₁O₁).

The derivation may be extended similarly/analogously to the 2D case, for example, with:

mₒₚₜ=mod(−(N₁O₁)d_{H}/λ sin(θ),N₁O₁)

and

nₒₚₜ=mod(−(N₂O₂)d_{V}/λ sin(φ),N₂O₂).

Accordingly, it may be understood that for the same network site and UE location, the preferred DFT beam vector as beamforming weight vector can be different with different antenna spacings at the base station antenna module.

Further, it may be understood that in CSI feedback, the PMI search does not need the explicit information regarding antenna spacings d_{H} and d_{V}.

From discussion above, we can see that for a given beam angle (θ, φ), the corresponding array response vector is characterized by (d_{H}/λ sin(θ), d_{V}/λ sin(φ)).

Taking a 1D array and O₁=1 for discussion purposes, to then generate the DFT beam vectors, the beam angles need to be satisfy

d_{H}/λ sin(B)=m/(N₁)

where in general the angle spacing among θ is not uniform as θ=sin⁻¹(m/N₁·λ/d_{H}), m=0, ±1, ±2, . . . .

Consider that an AI model is trained with a given set of beam angles at antenna spacing pair (d_{H}/λ=0.5, dᵥ/λ=0.5), but that that same AI model is used for a cell with (d_{H}/λ=0.4, dᵥ/λ=0.4). To make the model function with respect to these values of d_{H} and dᵥ, a uniform formulation may be used. Accordingly, first, as inputs to the AI model, for each measurement with a beam k from Set B beams that are used as input to the AI model, a triplet

(RSRP(k),s_{1,k},s_{2,k})

is generated, where s_{1,k} is horizontal beam angle of beam k in the digital domain, s_{2,k} is the vertical beam angle of beam k in the digital domain, and 1≤k≤N_{B}, where N_{B} is the number of beams in Set B.

Then, different antenna modules (e.g., with different antenna spacings) can be used in the same training session for an AI model, once the inputs are converted into the digital domain beam angles.

Further, given that an amplitude profile can be used to fit an AI model (for example as in the estimation of θ), the RSRP value(s) that are used as input(s) to the AI model are also normalized in the linear domain.

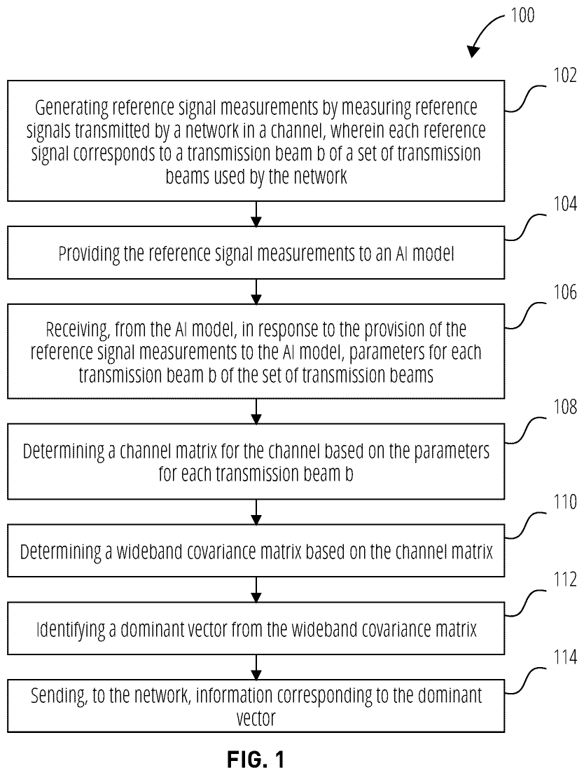

FIG. 1 illustrates a method 100 of a UE, according to embodiments discussed herein. The method 100 includes generating 102 reference signal measurements by measuring reference signals transmitted by a network in a channel, wherein each reference signal corresponds to a transmission beam b of a set of transmission beams used by the network. The method 100 further includes providing 104 the reference signal measurements to an AI model. The method 100 further includes receiving 106, from the AI model, in response to the provision of the reference signal measurements to the AI model, parameters for each transmission beam b of the set of transmission beams. The method 100 further includes determining 108 a channel matrix for the channel based on the parameters for each transmission beam b. The method 100 further includes determining 110 a wideband covariance matrix based on the channel matrix. The method 100 further includes identifying 112 a dominant vector from the wideband covariance matrix. The method 100 further includes sending 114, to the network, information corresponding to the dominant vector.

In some embodiments of the method 100, each transmission beam b uses an antenna polarization p of a set of antenna polarizations used by the network.

In some embodiments of the method 100, the information corresponding to the dominant vector comprises the dominant vector.

In some embodiments of the method 100, the information corresponding to the dominant vector comprises a phase of the dominant vector.

In some embodiments of the method 100, the parameters for each transmission beam b received from the AI model comprise θ_{b,p}, φ_{b,p},

$$\frac{{C}_{b , p}}{{C}_{\hat{b} , \overline{p}}} ,$$

and τ_{b,p} where: θ_{b,p} is a zenith departure angle of the transmission beam b under a polarization p; φ_{b,p} is an azimuth departure angle of the transmission beam b under the polarization p; C_{b,p} is a first connecting coefficient associating the transmission beam b under the polarization p with a corresponding delay and a corresponding first Doppler shift; C_{\hat{b},p̅} is a second connecting coefficient that is a largest connecting coefficient determined across the set of transmission beams under a set of antenna polarizations used by the network, wherein C_{\hat{b},p̅} is associated with a normalization transmission beam \hat{b} of the set of transmission beams under a normalization polarization p̅ of the set of antenna polarizations; and τ_{b,p} is a relative delay of the transmission beam b under the polarization p. In some such embodiments, the channel matrix is determined based on the parameters θ_{b,p}, φ_{b,p},

$$\frac{{C}_{b , p}}{{C}_{\hat{b} , \overline{p}}} ,$$

and τ_{b,p} using a formula:

$$H ( t ) = [ \begin{matrix}{\sum }_{p = 0 , b = 1}^{{B}_{0}} A ( {θ}_{b , p} , {ϕ}_{b , p} ) \frac{{C}_{b , p}}{{C}_{\hat{b} , \overline{p}}} δ ( t - {τ}_{b , p} ) \\ {\sum }_{p = 1 , b = 1}^{{B}_{1}} A ( {θ}_{b , p} , {ϕ}_{b , p} ) \frac{{C}_{b , p}}{{C}_{\hat{b} , \overline{p}}} δ ( t - {τ}_{b , p} )\end{matrix} ] .$$

In some such embodiments, the parameters for each transmission beam b received from the AI model further comprise f_{b,p}−f_{\hat{b},p̅}, where: f_{b,p} is the first Doppler shift of the transmission beam b under the polarization p; and f_{\hat{b},p̅} is a second Doppler shift of the normalization transmission beam \hat{b} under the normalization polarization p̅. In some of these cases, the channel matrix is determined based on the parameters θ_{b,p}, φ_{b,p},

$$\frac{{C}_{b , p}}{{C}_{\hat{b} , \overline{p}}} ,$$

τ_{b,p}, and f_{b,p}−f_{\hat{b},p̅} using a formula:

$$H ( t ) = [ \begin{matrix}{{{\sum }^{{B}_{0}}}_{p = 0 , b = 1}}^{} A ( {θ}_{b , p} , {ϕ}_{b , p} ) \frac{{C}_{b , p}}{{C}_{\hat{b} , \overline{p}}} {e}^{2 π ( {f}_{b , p} - {f}_{\hat{b} , \overline{p}} ) t} δ ( t - {τ}_{b , p} ) \\ {{\sum }^{{B}_{1}}}_{p = 1 , b = 1} A ( {θ}_{b , p} , {ϕ}_{b , p} ) \frac{{C}_{b , p}}{{C}_{\hat{b} , \overline{p}}} {e}^{2 π ( {f}_{b , p} - {f}_{\hat{b} , \overline{p}} ) t} δ ( t - {τ}_{b , p} )\end{matrix} ]$$

In some such embodiments, the parameters for each transmission beam b received from the AI model further comprise f_{b,p}, where: f_{b,p} is the first Doppler shift of the transmission beam b under the polarization p. In some of these cases, the channel matrix is determined based on the parameters θ_{b,p}, φ_{b,p},

$$\frac{{C}_{b , p}}{{C}_{\hat{b} , \overline{p}}} ,$$

τ_{b,p}, and f_{b,p} using a formula:

$$H ( t ) = [ \begin{matrix}{\sum }_{p = 0 , b = 1}^{{B}_{0}} A ( {θ}_{b , p} , {ϕ}_{b , p} ) \frac{{C}_{b , p}}{{C}_{\hat{b} , \overline{p}}} {e}^{2 π {f}_{b , p} t} δ ( t - {τ}_{b , p} ) \\ {\sum }_{p = 1 , b = 1}^{{B}_{1}} A ( {θ}_{b , p} , {ϕ}_{b , p} ) \frac{{C}_{b , p}}{{C}_{\hat{b} , \overline{p}}} {e}^{2 π {f}_{b , p} t} δ ( t - {τ}_{b , p} )\end{matrix} ]$$

In some embodiments, the method 100 further includes receiving, from the network, a first horizontal antenna spacing used by the network to transmit the reference signals and a first vertical antenna spacing used by the network to transmit the reference signals; and normalizing the reference signal measurements to account for one or more of: a first difference between the first horizontal antenna spacing and a second horizontal antenna spacing assumed by the AI model; and a second difference between the first vertical antenna spacing and a second vertical antenna spacing assumed by the AI model.

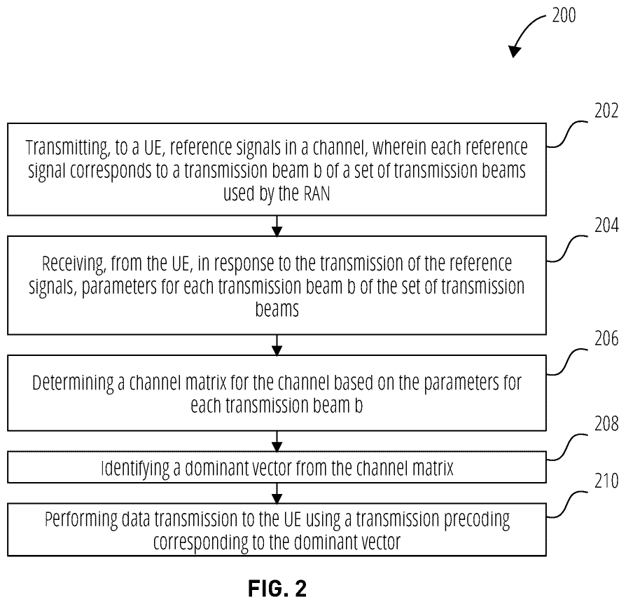

FIG. 2 illustrates a method 200 of a RAN, according to embodiments discussed herein. The method 200 includes transmitting 202, to a UE, reference signals in a channel, wherein each reference signal corresponds to a transmission beam b of a set of transmission beams used by the RAN. The method 200 further includes receiving 204, from the UE, in response to the transmission of the reference signals, parameters for each transmission beam b of the set of transmission beams. The method 200 further includes determining 206 a channel matrix for the channel based on the parameters for each transmission beam b. The method 200 further includes identifying 208 a dominant vector from the channel matrix. The method 200 further includes performing 210 data transmission to the UE using a transmission precoding corresponding to the dominant vector.

In some embodiments of the method 200, each transmission beam b uses an antenna polarization p of a set of antenna polarizations used by the RAN.

In some embodiments of the method 200, the parameters for each transmission beam b received from the UE comprise θ_{b,p}, φ_{b,p},

$$\frac{{C}_{b , p}}{{C}_{\hat{b} , \overline{p}}} ,$$

and τ_{b,p}, where: θ_{b,p} is a zenith departure angle of the transmission beam b under a polarization p; φ_{b,p} is an azimuth departure angle of the transmission beam b under the polarization p; C_{b,p} is a first connecting coefficient associating the transmission beam b under the polarization p with a corresponding delay and a corresponding first Doppler shift; C_{\hat{b},p̅} is a second connecting coefficient that is a largest connecting coefficient determined across the set of transmission beams under a set of antenna polarizations used by the network, wherein C_{\hat{b},p̅} is associated with a normalization transmission beam \hat{b} of the set of transmission beams under a normalization polarization p̅ of the set of antenna polarizations; and τ_{b,p} is a relative delay of the transmission beam b under the polarization p. In some such embodiments, the channel matrix is determined based on the parameters θ_{b,p}, φ_{b,p},

$$\frac{{C}_{b , p}}{{C}_{\hat{b} , \overline{p}}} ,$$

and τ_{b,p} using a formula:

$$H ( t ) = [ \begin{matrix}{\sum }_{p = 0 , b = 1}^{{B}_{0}} A ( {θ}_{b , p} , {ϕ}_{b , p} ) \frac{{C}_{b , p}}{{C}_{\hat{b} , \overline{p}}} δ ( t - {τ}_{b , p} ) \\ {\sum }_{p = 1 , b = 1}^{{B}_{1}} A ( {θ}_{b , p} , {ϕ}_{b , p} ) \frac{{C}_{b , p}}{{C}_{\hat{b} , \overline{p}}} δ ( t - {τ}_{b , p} )\end{matrix} ]$$

In some such embodiments, the parameters for each transmission beam b received from the UE further comprise f_{b,p}−f_{\hat{b},p̅}, where: f_{b,p} is the first Doppler shift of the transmission beam b under the polarization p; and f_{\hat{b},p̅} is a second Doppler shift of the normalization transmission beam \hat{b} under the normalization polarization p̅. In some of these cases, the channel matrix is determined based on the parameters θ_{b,p}, θ_{b,p}, φ_{b,p},

$$\frac{{C}_{b , p}}{{C}_{\hat{b} , \overline{p}}} ,$$

τ_{b,p}, and f_{b,p}−f_{\hat{b},p̅} using a formula:

$$H ( t ) = [ \begin{matrix}{\sum }_{p = 0 , b = 1}^{{B}_{0}} A ( {θ}_{b , p} , {ϕ}_{b , p} ) \frac{{C}_{b , p}}{{C}_{\hat{b} , \overline{p}}} {e}^{2 π ( {f}_{b , p} - {f}_{\hat{b} \overline{p}} ) t} δ ( t - {τ}_{b , p} ) \\ {\sum }_{p = 1 , b = 1}^{{B}_{1}} A ( {θ}_{b , p} , {ϕ}_{b , p} ) \frac{{C}_{b , p}}{{C}_{\hat{b} , \overline{p}}} {e}^{2 π ( {f}_{b , p} - {f}_{\hat{b} \overline{p}} ) t} δ ( t - {τ}_{b , p} )\end{matrix} ]$$

In some such embodiments, the parameters for each transmission beam b received from the UE further comprise f_{b,p}, where: f_{b,p} is the first Doppler shift of the transmission beam b under the polarization p. In some of these cases, the channel matrix is determined based on the parameters θ_{b,p}, θ_{b,p}, φ_{bp},

$$\frac{{C}_{b , p}}{{C}_{\hat{b} , \overline{p}}} ,$$

τ_{b,p}, and f_{b,p} using a formula:

$$H ( t ) = [ \begin{matrix}{\sum }_{p = 0 , b = 1}^{{B}_{0}} A ( {θ}_{b , p} , {ϕ}_{b , p} ) \frac{{C}_{b , p}}{{C}_{\hat{b} , \overline{p}}} {e}^{2 π {f}_{b , p} t} δ ( t - {τ}_{b , p} ) \\ {\sum }_{p = 1 , b = 1}^{{B}_{1}} A ( {θ}_{b , p} , {ϕ}_{b , p} ) \frac{{C}_{b , p}}{{C}_{\hat{b} , \overline{p}}} {e}^{2 π {f}_{b , p} t} δ ( t - {τ}_{b , p} )\end{matrix} ]$$

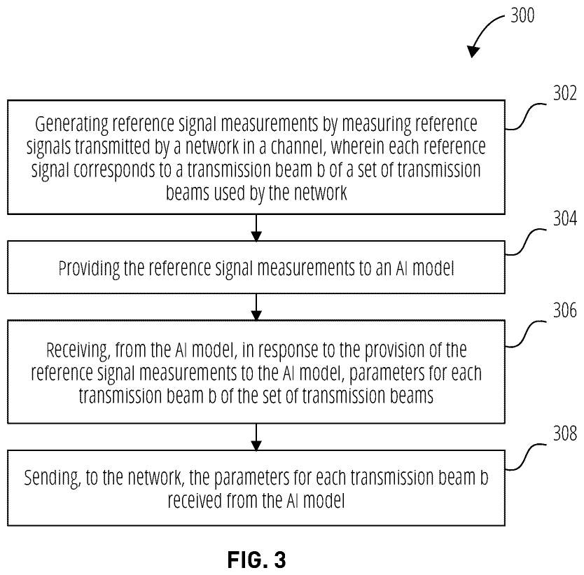

FIG. 3 illustrates a method 300 of a UE, according to embodiments discussed herein. The method 300 includes generating 302 reference signal measurements by measuring reference signals transmitted by a network in a channel, wherein each reference signal corresponds to a transmission beam b of a set of transmission beams used by the network. The method 300 further includes providing 304 the reference signal measurements to an AI model. The method 300 further includes receiving 306, from the AI model, in response to the provision of the reference signal measurements to the AI model, parameters for each transmission beam b of the set of transmission beams. The method 300 further includes sending 308, to the network, the parameters for each transmission beam b received from the AI model.

In some embodiments of the method 300, each transmission beam b uses an antenna polarization p of a set of antenna polarizations used by the network.

In some embodiments of the method 300, the parameters for each transmission beam b received from the AI model comprise θ_{b,p}, φ_{b,p},

$$\frac{{C}_{b , p}}{{C}_{\hat{b} , \overline{p}}} ,$$

and τ_{b,p}, where: θ_{b,p} is a zenith departure angle of the transmission beam b under a polarization p; φ_{b,p} is an azimuth departure angle of the transmission beam b under the polarization p; C_{b,p} is a first connecting coefficient associating the transmission beam b under the polarization p with a corresponding delay and a corresponding first Doppler shift; C_{\hat{b},p̅} is a second connecting coefficient that is a largest connecting coefficient determined across the set of transmission beams under a set of antenna polarizations used by the network, wherein C_{\hat{b},p̅} is associated with a normalization transmission beam \hat{b} of the set of transmission beams under a normalization polarization p̅ of the set of antenna polarizations; and τ_{b,p} is a relative delay of the transmission beam b under the polarization p. In some such embodiments, the parameters for each transmission beam b under each polarization p received from the AI model further comprise f_{b,p}−f_{\hat{b},p̅}, where: f_{b,p} is a is first Doppler shift of the transmission beam b under the polarization p; and f_{\hat{b},p̅} is a second Doppler shift of the normalization transmission beam \hat{b} under the normalization polarization p̅. In some such embodiments, the parameters for each transmission beam b received from the AI model further comprise f_{b,p}, where f_{b,p} is a is first Doppler shift of the transmission beam b under the polarization p.

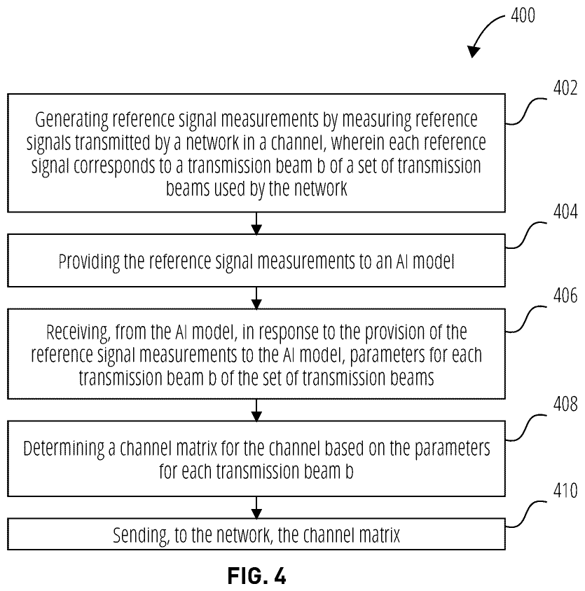

FIG. 4 illustrates a method 400 of a UE, according to embodiments discussed herein. The method 400 includes generating 402 reference signal measurements by measuring reference signals transmitted by a network in a channel, wherein each reference signal corresponds to a transmission beam b of a set of transmission beams used by the network. The method 400 further includes providing 404 the reference signal measurements to an AI model. The method 400 further includes receiving 406, from the AI model, in response to the provision of the reference signal measurements to the AI model, parameters for each transmission beam b of the set of transmission beams. The method 400 further includes determining 408 a channel matrix for the channel based on the parameters for each transmission beam b. The method 400 further includes sending 410, to the network, the channel matrix.

In some embodiments of the method 400, each transmission beam b uses an antenna polarization p of a set of antenna polarizations used by the network.

In some embodiments of the method 400, the parameters for each transmission beam b received from the AI model comprise θ_{b,p}, φ_{b,p},

$$\frac{{C}_{b , p}}{{C}_{\hat{b} , \overline{p}}} ,$$

and τ_{b,p}, where: τ_{b,p} is a zenith departure angle of the transmission beam b under the polarization p; φ_{b,p} is an azimuth departure angle of the transmission beam b under a polarization p; C_{b,p} is a first connecting coefficient associating the transmission beam b under the polarization p with a corresponding delay and a first Doppler shift; C_{\hat{b},p̅} is a second connecting coefficient that is a largest connecting coefficient determined across the set of transmission beams under a set of antenna polarizations used by the network, wherein C_{\hat{b},p̅} is associated with a normalization transmission beam \hat{b} of the set of transmission beams under a normalization polarization p̅ of the set of antenna polarizations; and τ_{b,p} is a relative delay of the transmission beam b under the polarization p. In some such embodiments, the channel matrix is determined based on the parameters θ_{b,p}, φ_{b,p},

$$\frac{{C}_{b , p}}{{C}_{\hat{b} , \overline{p}}} ,$$

and τ_{b,p} using a formula:

$$H ( t ) = [ \begin{matrix}{\sum }_{p = 0 , b = 1}^{{B}_{0}} A ( {θ}_{b , p} , {ϕ}_{b , p} ) \frac{{C}_{b , p}}{{C}_{\hat{b} , \overline{p}}} δ ( t - {τ}_{b , p} ) \\ {\sum }_{p = 1 , b = 1}^{{B}_{1}} A ( {θ}_{b , p} , {ϕ}_{b , p} ) \frac{{C}_{b , p}}{{C}_{\hat{b} , \overline{p}}} δ ( t - {τ}_{b , p} )\end{matrix} ]$$

In some such embodiments, the parameters for each transmission beam b received from the AI model further comprise f_{b,p}−f_{\hat{b},p̅}, where: f_{b,p} is the first Doppler shift of the transmission beam b under the polarization p; and f_{\hat{b},p̅} is a second Doppler shift of the normalization transmission beam \hat{b} under the normalization polarization p̅. In some of these cases, the channel matrix is determined based on the parameters θ_{b,p}, θ_{b,p}, φ_{b,p},

$$\frac{{C}_{b , p}}{{C}_{\hat{b} , \overline{p}}} ,$$

τ_{b,p}, and f_{b,p}−f_{\hat{b},p̅} using a formula:

$$H ( t ) = [ \begin{matrix}{\sum }_{p = 0 , b = 1}^{{B}_{0}} A ( {θ}_{b , p} , {ϕ}_{b , p} ) \frac{{C}_{b , p}}{{C}_{\hat{b} , \overline{p}}} {e}^{2 π ( {f}_{b , p} - {f}_{\hat{b} \overline{p}} ) t} δ ( t - {τ}_{b , p} ) \\ {\sum }_{p = 1 , b = 1}^{{B}_{1}} A ( {θ}_{b , p} , {ϕ}_{b , p} ) \frac{{C}_{b , p}}{{C}_{\hat{b} , \overline{p}}} {e}^{2 π ( {f}_{b , p} - {f}_{\hat{b} \overline{p}} ) t} δ ( t - {τ}_{b , p} )\end{matrix} ]$$

In some such embodiments, the parameters for each transmission beam b received from the AI model further comprise f_{b,p}, where: f_{b,p} is the first Doppler shift of the transmission beam b under the polarization p. In some of these cases, the channel matrix is determined based on the parameters θ_{b,p}, θ_{b,p}, φ_{b,p},

$$\frac{{C}_{b , p}}{{C}_{\hat{b} , \overline{p}}} ,$$

τ_{b,p}, and f_{b,p} using a formula:

$$H ( t ) = [ \begin{matrix}{\sum }_{p = 0 , b = 1}^{{B}_{0}} A ( {θ}_{b , p} , {ϕ}_{b , p} ) \frac{{C}_{b , p}}{{C}_{\hat{b} , \overline{p}}} {e}^{2 π {f}_{b , p} t} δ ( t - {τ}_{b , p} ) \\ {\sum }_{p = 1 , b = 1}^{{B}_{1}} A ( {θ}_{b , p} , {ϕ}_{b , p} ) \frac{{C}_{b , p}}{{C}_{\hat{b} , \overline{p}}} {e}^{2 π {f}_{b , p} t} δ ( t - {τ}_{b , p} )\end{matrix} ]$$

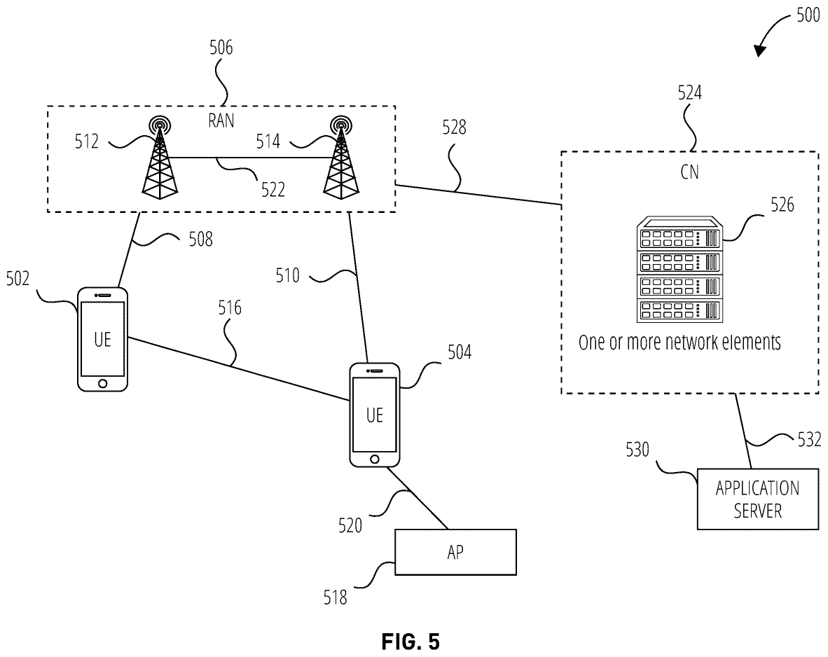

FIG. 5 illustrates an example architecture of a wireless communication system 500, according to embodiments disclosed herein. The following description is provided for an example wireless communication system 500 that operates in conjunction with the LTE system standards and/or 5G or NR system standards as provided by 3GPP technical specifications.

As shown by FIG. 5, the wireless communication system 500 includes UE 502 and UE 504 (although any number of UEs may be used). In this example, the UE 502 and the UE 504 are illustrated as smartphones (e.g., handheld touchscreen mobile computing devices connectable to one or more cellular networks), but may also comprise any mobile or non-mobile computing device configured for wireless communication.

The UE 502 and UE 504 may be configured to communicatively couple with a RAN 506. In embodiments, the RAN 506 may be NG-RAN, E-UTRAN, etc. The UE 502 and UE 504 utilize connections (or channels) (shown as connection 508 and connection 510, respectively) with the RAN 506, each of which comprises a physical communications interface. The RAN 506 can include one or more base stations (such as base station 512 and base station 514) that enable the connection 508 and connection 510.

In this example, the connection 508 and connection 510 are air interfaces to enable such communicative coupling, and may be consistent with RAT(s) used by the RAN 506, such as, for example, an LTE and/or NR.

In some embodiments, the UE 502 and UE 504 may also directly exchange communication data via a sidelink interface 516. The UE 504 is shown to be configured to access an access point (shown as AP 518) via connection 520. By way of example, the connection 520 can comprise a local wireless connection, such as a connection consistent with any IEEE 802.11 protocol, wherein the AP 518 may comprise a Wi-Fi® router. In this example, the AP 518 may be connected to another network (for example, the Internet) without going through a CN 524.

In embodiments, the UE 502 and UE 504 can be configured to communicate using orthogonal frequency division multiplexing (OFDM) communication signals with each other or with the base station 512 and/or the base station 514 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 512 or base station 514 may be implemented as one or more software entities running on server computers as part of a virtual network. In addition, or in other embodiments, the base station 512 or base station 514 may be configured to communicate with one another via interface 522. In embodiments where the wireless communication system 500 is an LTE system (e.g., when the CN 524 is an EPC), the interface 522 may be an X2 interface. The X2 interface may be defined between two or more base stations (e.g., two or more eNBs and the like) that connect to an EPC, and/or between two eNBs connecting to the EPC. In embodiments where the wireless communication system 500 is an NR system (e.g., when CN 524 is a 5GC), the interface 522 may be an Xn interface. The Xn interface is defined between two or more base stations (e.g., two or more gNBs and the like) that connect to 5GC, between a base station 512 (e.g., a gNB) connecting to 5GC and an eNB, and/or between two eNBs connecting to 5GC (e.g., CN 524).

The RAN 506 is shown to be communicatively coupled to the CN 524. The CN 524 may comprise one or more network elements 526, which are configured to offer various data and telecommunications services to customers/subscribers (e.g., users of UE 502 and UE 504) who are connected to the CN 524 via the RAN 506. The components of the CN 524 may be implemented in one physical device or separate physical devices including components to read and execute instructions from a machine-readable or computer-readable medium (e.g., a non-transitory machine-readable storage medium).

In embodiments, the CN 524 may be an EPC, and the RAN 506 may be connected with the CN 524 via an S1 interface 528. In embodiments, the S1 interface 528 may be split into two parts, an S1 user plane (S1-U) interface, which carries traffic data between the base station 512 or base station 514 and a serving gateway (S-GW), and the S1-MME interface, which is a signaling interface between the base station 512 or base station 514 and mobility management entities (MMEs).

In embodiments, the CN 524 may be a 5GC, and the RAN 506 may be connected with the CN 524 via an NG interface 528. In embodiments, the NG interface 528 may be split into two parts, an NG user plane (NG-U) interface, which carries traffic data between the base station 512 or base station 514 and a user plane function (UPF), and the S1 control plane (NG-C) interface, which is a signaling interface between the base station 512 or base station 514 and access and mobility management functions (AMFs).

Generally, an application server 530 may be an element offering applications that use internet protocol (IP) bearer resources with the CN 524 (e.g., packet switched data services). The application server 530 can also be configured to support one or more communication services (e.g., VoIP sessions, group communication sessions, etc.) for the UE 502 and UE 504 via the CN 524. The application server 530 may communicate with the CN 524 through an IP communications interface 532.

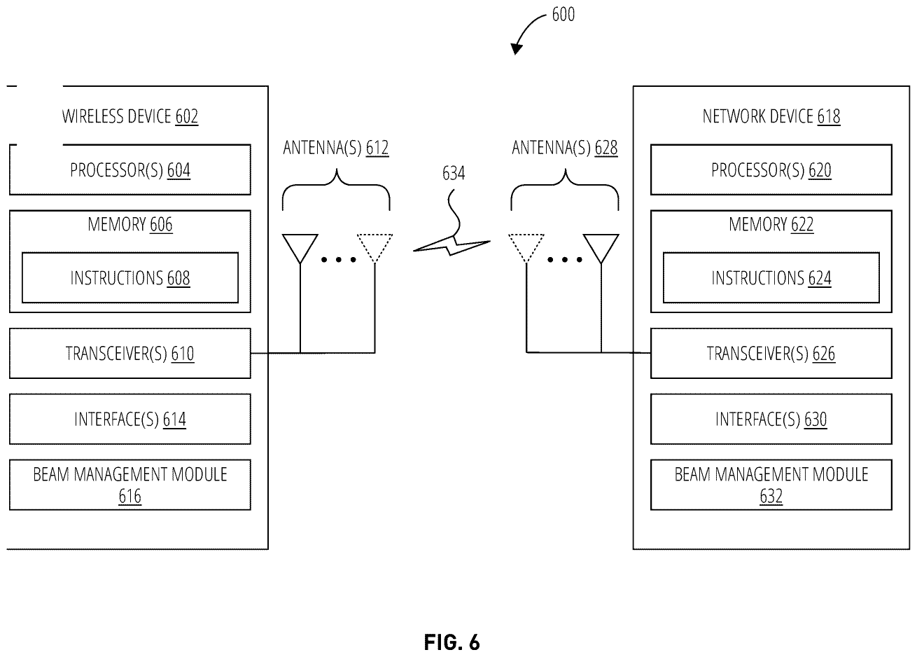

FIG. 6 illustrates a system 600 for performing signaling 634 between a wireless device 602 and a network device 618, according to embodiments disclosed herein. The system 600 may be a portion of a wireless communications system as herein described. The wireless device 602 may be, for example, a UE of a wireless communication system. The network device 618 may be, for example, a base station (e.g., an eNB or a gNB) of a wireless communication system.

The wireless device 602 may include one or more processor(s) 604. The processor(s) 604 may execute instructions such that various operations of the wireless device 602 are performed, as described herein. The processor(s) 604 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 602 may include a memory 606. The memory 606 may be a non-transitory computer-readable storage medium that stores instructions 608 (which may include, for example, the instructions being executed by the processor(s) 604). The instructions 608 may also be referred to as program code or a computer program. The memory 606 may also store data used by, and results computed by, the processor(s) 604.

The wireless device 602 may include one or more transceiver(s) 610 that may include radio frequency (RF) transmitter and/or receiver circuitry that use the antenna(s) 612 of the wireless device 602 to facilitate signaling (e.g., the signaling 634) to and/or from the wireless device 602 with other devices (e.g., the network device 618) according to corresponding RATs.

The wireless device 602 may include one or more antenna(s) 612 (e.g., one, two, four, or more). For embodiments with multiple antenna(s) 612, the wireless device 602 may leverage the spatial diversity of such multiple antenna(s) 612 to send and/or receive multiple different data streams on the same time and frequency resources. This behavior may be referred to as, for example, MIMO behavior (referring to the multiple antennas used at each of a transmitting device and a receiving device that enable this aspect). MIMO transmissions by the wireless device 602 may be accomplished according to precoding (or digital beamforming) that is applied at the wireless device 602 that multiplexes the data streams across the antenna(s) 612 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 602 may implement analog beamforming techniques, whereby phases of the signals sent by the antenna(s) 612 are relatively adjusted such that the (joint) transmission of the antenna(s) 612 can be directed (this is sometimes referred to as beam steering).

The wireless device 602 may include one or more interface(s) 614. The interface(s) 614 may be used to provide input to or output from the wireless device 602. For example, a wireless device 602 that is a UE may include interface(s) 614 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 610/antenna(s) 612 already described) that allow for communication between the UE and other devices and may operate according to known protocols (e.g., Wi-Fi®, Bluetooth®, and the like).

The wireless device 602 may include a beam management module 616. The beam management module 616 may be implemented via hardware, software, or combinations thereof. For example, the beam management module 616 may be implemented as a processor, circuit, and/or instructions 608 stored in the memory 606 and executed by the processor(s) 604. In some examples, the beam management module 616 may be integrated within the processor(s) 604 and/or the transceiver(s) 610. For example, the beam management module 616 may be implemented by a combination of software components (e.g., executed by a DSP or a general processor) and hardware components (e.g., logic gates and circuitry) within the processor(s) 604 or the transceiver(s) 610.

The beam management module 616 may be used for various aspects of the present disclosure, for example, aspects of FIG. 1 through FIG. 4. The beam management module 616 may be configured to, for example, perform or cause to be performed reference signal measurements at the wireless device 602, provide the reference signal measurements to an AI model, receive corresponding parameters for each transmission beam b of a set of transmission beams under each polarization p from the AI model, and perform further tasks with such parameters (e.g., determining a channel matrix/corresponding dominant vector to feed back to the network, feed back the parameters to the network directly for use at the network, etc.).

The network device 618 may include one or more processor(s) 620. The processor(s) 620 may execute instructions such that various operations of the network device 618 are performed, as described herein. The processor(s) 620 may include one or more baseband processors implemented using, for example, a CPU, a DSP, an ASIC, a controller, an FPGA device, another hardware device, a firmware device, or any combination thereof configured to perform the operations described herein.

The network device 618 may include a memory 622. The memory 622 may be a non-transitory computer-readable storage medium that stores instructions 624 (which may include, for example, the instructions being executed by the processor(s) 620). The instructions 624 may also be referred to as program code or a computer program. The memory 622 may also store data used by, and results computed by, the processor(s) 620.

The network device 618 may include one or more transceiver(s) 626 that may include RF transmitter and/or receiver circuitry that use the antenna(s) 628 of the network device 618 to facilitate signaling (e.g., the signaling 634) to and/or from the network device 618 with other devices (e.g., the wireless device 602) according to corresponding RATs.

The network device 618 may include one or more antenna(s) 628 (e.g., one, two, four, or more). In embodiments having multiple antenna(s) 628, the network device 618 may perform MIMO, digital beamforming, analog beamforming, beam steering, etc., as has been described.

The network device 618 may include one or more interface(s) 630. The interface(s) 630 may be used to provide input to or output from the network device 618. For example, a network device 618 that is a base station may include interface(s) 630 made up of transmitters, receivers, and other circuitry (e.g., other than the transceiver(s) 626/antenna(s) 628 already described) that enables the base station to communicate with other equipment in a core network, and/or that enables the base station to communicate with external networks, computers, databases, and the like for purposes of operations, administration, and maintenance of the base station or other equipment operably connected thereto.

The network device 618 may include a beam management module 632. The beam management module 632 may be implemented via hardware, software, or combinations thereof. For example, the beam management module 632 may be implemented as a processor, circuit, and/or instructions 624 stored in the memory 622 and executed by the processor(s) 620. In some examples, the beam management module 632 may be integrated within the processor(s) 620 and/or the transceiver(s) 626. For example, the beam management module 632 may be implemented by a combination of software components (e.g., executed by a DSP or a general processor) and hardware components (e.g., logic gates and circuitry) within the processor(s) 620 or the transceiver(s) 626.

The beam management module 632 may be used for various aspects of the present disclosure, for example, aspects of FIG. 1 through FIG. 4. The beam management module 632 may be configured to, for example, transmit or cause to be transmitted reference signal measurements by the network device 618, and receive in response, from a UE, a channel matrix/corresponding dominant vector for use by the network device 618, parameters for each transmission beam b of a set of transmission beams under each polarization p (for use at the network to itself determine a channel matrix/corresponding dominant vector for use), etc.

Embodiments contemplated herein include an apparatus comprising means to perform one or more elements of any one or more of the method 100, the method 300, and the method 400. This apparatus may be, for example, an apparatus of a UE (such as a wireless device 602 that is a UE, as described herein).

Embodiments contemplated herein include one or more non-transitory computer-readable media comprising instructions to cause an electronic device, upon execution of the instructions by one or more processors of the electronic device, to perform one or more elements any one or more of the method 100, the method 300, and the method 400. This non-transitory computer-readable media may be, for example, a memory of a UE (such as a memory 606 of a wireless device 602 that is a UE, as described herein).

Embodiments contemplated herein include an apparatus comprising logic, modules, or circuitry to perform one or more elements of any one or more of the method 100, the method 300, and the method 400. This apparatus may be, for example, an apparatus of a UE (such as a wireless device 602 that is a UE, as described herein).

Embodiments contemplated herein include an apparatus comprising: one or more processors and one or more computer-readable media comprising instructions that, when executed by the one or more processors, cause the one or more processors to perform one or more elements of any one or more of the method 100, the method 300, and the method 400. This apparatus may be, for example, an apparatus of a UE (such as a wireless device 602 that is a UE, as described herein).

Embodiments contemplated herein include a signal as described in or related to one or more elements of any one or more of the method 100, the method 300, and the method 400.

Embodiments contemplated herein include a computer program or computer program product comprising instructions, wherein execution of the program by a processor is to cause the processor to carry out one or more elements of any one or more of the method 100, the method 300, and the method 400. The processor may be a processor of a UE (such as a processor(s) 604 of a wireless device 602 that is a UE, as described herein). These instructions may be, for example, located in the processor and/or on a memory of the UE (such as a memory 606 of a wireless device 602 that is a UE, as described herein).

Embodiments contemplated herein include an apparatus comprising means to perform one or more elements of the method 200. This apparatus may be, for example, an apparatus of a base station (such as a network device 618 that is a base station, as described herein).

Embodiments contemplated herein include one or more non-transitory computer-readable media comprising instructions to cause an electronic device, upon execution of the instructions by one or more processors of the electronic device, to perform one or more elements of the method 200. This non-transitory computer-readable media may be, for example, a memory of a base station (such as a memory 622 of a network device 618 that is a base station, as described herein).

Embodiments contemplated herein include an apparatus comprising logic, modules, or circuitry to perform one or more elements of the method 200. This apparatus may be, for example, an apparatus of a base station (such as a network device 618 that is a base station, as described herein).

Embodiments contemplated herein include an apparatus comprising: one or more processors and one or more computer-readable media comprising instructions that, when executed by the one or more processors, cause the one or more processors to perform one or more elements of the method 200. This apparatus may be, for example, an apparatus of a base station (such as a network device 618 that is a base station, as described herein).

Embodiments contemplated herein include a signal as described in or related to one or more elements of the method 200.

Embodiments contemplated herein include a computer program or computer program product comprising instructions, wherein execution of the program by a processing element is to cause the processing element to carry out one or more elements of the method 200. The processor may be a processor of a base station (such as a processor(s) 620 of a network device 618 that is a base station, as described herein). These instructions may be, for example, located in the processor and/or on a memory of the base station (such as a memory 622 of a network device 618 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a user equipment (UE), comprising:
generating reference signal measurements by measuring reference signals transmitted by a network in a channel, wherein each reference signal corresponds to a transmission beam b of a set of transmission beams used by the network;
providing the reference signal measurements to an artificial intelligence (AI) model;
receiving, from the AI model, in response to the provision of the reference signal measurements to the AI model, parameters for each transmission beam b of the set of transmission beams;
determining a channel matrix for the channel based on the parameters for each transmission beam b;
determining a wideband covariance matrix based on the channel matrix;
identifying a dominant vector from the wideband covariance matrix; and
sending, to the network, information corresponding to the dominant vector.

2. The method of claim 1, wherein each transmission beam b uses an antenna polarization p of a set of antenna polarizations used by the network.

3. The method of claim 1, wherein the information corresponding to the dominant vector comprises the dominant vector.

4. The method of claim 1, wherein the information corresponding to the dominant vector comprises a phase of the dominant vector.

5. The method of claim 1, wherein the parameters for each transmission beam b received from the AI model comprise θ_{b,p}, φ_{b,p},
$$\frac{{C}_{b , p}}{{C}_{\hat{b} , \overline{p}}} ,$$
and τ_{b,p}, where:
θ_{b,p} is a zenith departure angle of the transmission beam b under a polarization p;
φ_{b,p} is an azimuth departure angle of the transmission beam b under the polarization p;
C_{b,p} is a first connecting coefficient associating the transmission beam b under the polarization p with a corresponding delay and a corresponding first Doppler shift;
C_{\hat{b},p̅} is a second connecting coefficient that is a largest connecting coefficient determined across the set of transmission beams under a set of antenna polarizations used by the network, wherein C_{\hat{b},p̅} is associated with a normalization transmission beam \hat{b} of the set of transmission beams under a normalization polarization p̅ of the set of antenna polarizations; and
τ_{b,p} is a relative delay of the transmission beam b under the polarization p.

6. The method of claim 5, wherein the channel matrix is determined based on the parameters θ_{b,p}, φ_{b,p},
$$\frac{{C}_{b , p}}{{C}_{\hat{b} , \overline{p}}} ,$$
and τ_{b,p} using a formula:
$$H ( t ) = [ \begin{matrix}{\sum }_{p = 0 , b = 1}^{{B}_{0}} A ( {θ}_{b , p} , {ϕ}_{b , p} ) \frac{{C}_{b , p}}{{C}_{\hat{b} , \overline{p}}} δ ( t - {τ}_{b , p} ) \\ {\sum }_{p = 1 , b = 1}^{{B}_{1}} A ( {θ}_{b , p} , {ϕ}_{b , p} ) \frac{{C}_{b , p}}{{C}_{\hat{b} , \overline{p}}} δ ( t - {τ}_{b , p} )\end{matrix} ] .$$

7. The method of claim 5, wherein the parameters for each transmission beam b received from the AI model further comprise f_{b,p}−f_{\hat{b},p̅}, where:
f_{b,p} is the first Doppler shift of the transmission beam b under the polarization p; and
f_{\hat{b},p̅} is a second Doppler shift of the normalization transmission beam \hat{b} under the normalization polarization p̅.

8. The method of claim 7, wherein the channel matrix is determined based on the parameters θ_{b,p}, φ_{b,p},
$$\frac{{C}_{b , p}}{{C}_{\hat{b} , \overline{p}}} ,$$
and f_{b,p}−f_{\hat{b},p̅} using a formula:
$$H ( t ) = [ \begin{matrix}{\sum }_{p = 0 , b = 1}^{{B}_{0}} A ( {θ}_{b , p} , {ϕ}_{b , p} ) \frac{{C}_{b , p}}{{C}_{\hat{b} , \overline{p}}} {e}^{2 π ( {f}_{b , p} - {f}_{\hat{b} , \overline{p}} ) t} δ ( t - {τ}_{b , p} ) \\ {\sum }_{p = 1 , b = 1}^{{B}_{1}} A ( {θ}_{b , p} , {ϕ}_{b , p} ) \frac{{C}_{b , p}}{{C}_{\hat{b} , \overline{p}}} {e}^{2 π ( {f}_{b , p} - {f}_{\hat{b} , \overline{p}} ) t} δ ( t - {τ}_{b , p} )\end{matrix} ] .$$

9. The method of claim 5, wherein the parameters for each transmission beam b received from the AI model further comprise f_{b,p}, where f_{b,p} is the first Doppler shift of the transmission beam b under the polarization p

10. The method of claim 9, wherein the channel matrix is determined based on the parameters θ_{b,p}, φ_{b,p},
$$\frac{{C}_{b , p}}{{C}_{\hat{b} , \overline{p}}} ,$$
τ_{b,p}, and f_{b,p} using a formula:
$$H ( t ) = [ \begin{matrix}{\sum }_{p = 0 , b = 1}^{{B}_{0}} A ( {θ}_{b , p} , {ϕ}_{b , p} ) \frac{{C}_{b , p}}{{C}_{\hat{b} , \overline{p}}} {e}^{2 π {f}_{b , p} t} δ ( t - {τ}_{b , p} ) \\ {\sum }_{p = 1 , b = 1}^{{B}_{1}} A ( {θ}_{b , p} , {ϕ}_{b , p} ) \frac{{C}_{b , p}}{{C}_{\hat{b} , \overline{p}}} {e}^{2 π {f}_{b , p} t} δ ( t - {τ}_{b , p} )\end{matrix} ] .$$

11. The method of claim 1, further comprising:
receiving, from the network, a first horizontal antenna spacing used by the network to transmit the reference signals and a first vertical antenna spacing used by the network to transmit the reference signals; and
normalizing the reference signal measurements to account for one or more of:
a first difference between the first horizontal antenna spacing and a second horizontal antenna spacing assumed by the AI model; and
a second difference between the first vertical antenna spacing and a second vertical antenna spacing assumed by the AI model.

12. A method of a radio access network (RAN), comprising:
transmitting, to a user equipment (UE), reference signals in a channel, wherein each reference signal corresponds to a transmission beam b of a set of transmission beams used by the RAN;
receiving, from the UE, in response to the transmission of the reference signals, parameters for each transmission beam b of the set of transmission beams;
determining a channel matrix for the channel based on the parameters for each transmission beam b;
identifying a dominant vector from the channel matrix; and
performing data transmission to the UE using a transmission precoding corresponding to the dominant vector.

13. The method of claim 12, wherein each transmission beam b uses an antenna polarization p of a set of antenna polarizations used by the RAN.

14. The method of claim 12, wherein the parameters for each transmission beam b received from the UE comprise θ_{b,p}, φ_{b,p},
$$\frac{{C}_{b , p}}{{C}_{\hat{b} , \overline{p}}} ,$$
and τ_{b,p}, where:
θ_{b,p} is a zenith departure angle of the transmission beam b under a polarization p;
φ_{b,p} is an azimuth departure angle of the transmission beam b under the polarization p;
C_{b,p} is a first connecting coefficient associating the transmission beam b under the polarization p with a corresponding delay and a corresponding first Doppler shift;
C_{\hat{b},p̅} is a second connecting coefficient that is a largest connecting coefficient determined across the set of transmission beams under a set of antenna polarizations used by the network, wherein C_{\hat{b},p̅} is associated with a normalization transmission beam \hat{b} of the set of transmission beams under a normalization polarization p̅ of the set of antenna polarizations; and
τ_{b,p} is a relative delay of the transmission beam b under the polarization p.

15. The method of claim 14, wherein the channel matrix is determined based on the parameters θ_{b,p}, φ_{b,p},
$$\frac{{C}_{b , p}}{{C}_{\hat{b} , \overline{p}}} ,$$
and τ_{b,p} using a formula:
$$H ( t ) = [ \begin{matrix}{\sum }_{p = 0 , b = 1}^{{B}_{0}} A ( {θ}_{b , p} , {ϕ}_{b , p} ) \frac{{C}_{b , p}}{{C}_{\hat{b} , \overline{p}}} δ ( t - {τ}_{b , p} ) \\ {\sum }_{p = 1 , b = 1}^{{B}_{1}} A ( {θ}_{b , p} , {ϕ}_{b , p} ) \frac{{C}_{b , p}}{{C}_{\hat{b} , \overline{p}}} δ ( t - {τ}_{b , p} )\end{matrix} ] .$$

16. The method of claim 14, wherein the parameters for each transmission beam b received from the UE further comprise f_{b,p}−f_{\hat{b},p̅}, where:
f_{b,p} is the first Doppler shift of the transmission beam b under the polarization p; and
f_{b,p} is a second Doppler shift of the normalization transmission beam \hat{b} under the normalization polarization p̅.

17. The method of claim 16, wherein the channel matrix is determined based on the parameters θ_{b,p}, φ_{b,p},
$$\frac{{C}_{b , p}}{{C}_{\hat{b} , \overline{p}}} ,$$
τ_{b,p}, and f_{b,p}−f_{\hat{b},p̅} using a formula:
$$H ( t ) = [ \begin{matrix}{\sum }_{p = 0 , b = 1}^{{B}_{0}} A ( {θ}_{b , p} , {ϕ}_{b , p} ) \frac{{C}_{b , p}}{{C}_{\hat{b} , \overline{p}}} {e}^{2 π ( {f}_{b , p} - {f}_{\hat{b} , \overline{p}} ) t} δ ( t - {τ}_{b , p} ) \\ {\sum }_{p = 1 , b = 1}^{{B}_{1}} A ( {θ}_{b , p} , {ϕ}_{b , p} ) \frac{{C}_{b , p}}{{C}_{\hat{b} , \overline{p}}} {e}^{2 π ( {f}_{b , p} - {f}_{\hat{b} , \overline{p}} ) t} δ ( t - {τ}_{b , p} )\end{matrix} ] .$$

18. The method of claim 14, wherein the parameters for each transmission beam b received from the UE further comprise f_{b,p}, where f_{b,p} is the first Doppler shift of the transmission beam b under the polarization p.

19. The method of claim 18, wherein the channel matrix is determined based on the parameters θ_{b,p}, φ_{b,p},
$$\frac{{C}_{b , p}}{{C}_{\hat{b} , \overline{p}}} ,$$
τ_{b,p}, and f_{b,p} using a formula:
$$H ( t ) = [ \begin{matrix}{\sum }_{p = 0 , b = 1}^{{B}_{0}} A ( {θ}_{b , p} , {ϕ}_{b , p} ) \frac{{C}_{b , p}}{{C}_{\hat{b} , \overline{p}}} {e}^{2 π {f}_{b , p} t} δ ( t - {τ}_{b , p} ) \\ {\sum }_{p = 1 , b = 1}^{{B}_{1}} A ( {θ}_{b , p} , {ϕ}_{b , p} ) \frac{{C}_{b , p}}{{C}_{\hat{b} , \overline{p}}} {e}^{2 π {f}_{b , p} t} δ ( t - {τ}_{b , p} )\end{matrix} ] .$$

20. A method of a user equipment (UE), comprising:
generating reference signal measurements by measuring reference signals transmitted by a network in a channel, wherein each reference signal corresponds to a transmission beam b of a set of transmission beams used by the network;
providing the reference signal measurements to an artificial intelligence (AI) model;
receiving, from the AI model, in response to the provision of the reference signal measurements to the AI model, parameters for each transmission beam b of the set of transmission beams; and
sending, to the network, the parameters for each transmission beam b received from the AI model.

21-35. (canceled)
